(19) United States
(12) Patent Application Publication
(10) Pub. No.: US 2014/0217108 A1
(43) Pub. Date: Aug. 7, 2014

(54) STAND FOR CARBON DIOXIDE HORN AND ACCESSORY

(71) Applicant: QUARK LIMITED, LDC, Belize City (BZ)

(72) Inventors: Donald A. Santeler, Genoa, IL (US); Robert W. Hallock, Chicago, IL (US)

(73) Assignee: QUARK LIMITED, LDC, Belize City (BZ)

(21) Appl. No.: 13/760,170

(22) Filed: Feb. 6, 2013

(51) Int. Cl. F16M 11/00

(52) U.S. Cl. CPC F16M 11/00
USPC 220/737; 248/121

(57) ABSTRACT

A stand for a hand-operated carbon dioxide discharge horn. The stand can retain the hand-operated carbon dioxide discharge horn without having to be stored near the compressed gas source. The stand also includes a protrusion for storing an accessory associated with the hand-operated carbon dioxide discharge horn. Also disclosed is a kit containing a stand, hand-operated carbon dioxide discharge horn and an accessory for hand-operated discharge horn.

### CROSS REFERENCE TO RELATED APPLICATIONS

None.

### FIELD OF THE INVENTION

The invention relates to a stand for a hand-operated carbon dioxide discharge horn.

### BACKGROUND OF THE INVENTION

Carbon dioxide discharge horns can be used, for example, to deposit solid carbon dioxide (also referred to as carbon dioxide snow) in containers. The solid carbon dioxide can keep objects in the containers cold so that the container (and object) may be shipped, stored, etc.

Some carbon dioxide discharge horns (also sometimes referred to as “nozzles”) are in a fixed position, for example, above a conveyor belt. As objects/containers pass below the discharge horn, snow is deposited onto the objects/into the containers—as well as onto the conveyor belt moving the boxes.

Other carbon dioxide discharge horns are hand-operated. These types of discharge horns are more efficient because they directly deposit the carbon dioxide snow into the container. In addition, these horns can efficiently fill a variety of differently sized containers. Thus, these types of discharge horns are desirable.

The assignee of the present application has co-pending applications directed to such hand-operated discharge horns. U.S. pat. appl. Ser. No. 13/621,970, filed on Sep. 18, 2012 (the entirety of which is incorporated herein by reference), discloses various embodiments and designs for a hand-operated discharge horn. Such hand-operated discharge horns utilize tubing to connect to a source of carbon dioxide, like a compressed air tank.

Some such hand-operated discharge horns utilize accessories, like an overblow shield, such as the one disclosed in U.S. pat. appl. Ser. No. 13/669,647, filed on Nov. 6, 2012, and assigned to the present assignee (the entirety of which is incorporated herein by reference).

Since the discharge horns are hand-operated, it is believed to be desirable to have a stand to store the discharge horn when the discharge horns are not in use.

In addition, since some hand-operated discharge horns are used with a gas source that is immovable, it is also believed to be beneficial to have a stand that is easy to set up, is easily movable, and is not fixed in position with respect to the gas source.

Moreover, since many hand-operated discharge horns may include accessories, like an overblow shield, it is believed to be desirable that a stand be capable of supporting such an accessory.

Accordingly, the present invention is directed to providing such a stand.

### SUMMARY OF THE INVENTION

In one embodiment, the invention provides a stand for a hand-operated discharge horn. The stand includes a body having a top and a bottom and the bottom forms a leg.

An outrigger member intersects the body at a point between the top and the bottom. The outrigger member has a middle portion and two end portions and each end portion forms a leg.

The stand includes at least one bracket for hanging a hand-operated discharge horn. The bracket(s) is (are) positioned on the body between the point the outrigger member intersects the body and the top.

Finally, the stand also includes a protrusion disposed on the body for hanging an accessory for the hand-operated discharge horn. The protrusion may be positioned on the body between the point the outrigger member intersects the body and the top.

It is contemplated that the bracket(s) is (are) disposed on a first side of the body, and the protrusion is disposed on a second side of the body which is different than the first side. It is preferred that the second side is opposite the first side. Such a configuration will increase the space available to store the hand-operated discharge horn and the accessory.

It is also contemplated that the legs support the body such that the body is angled.

In a preferred embodiment, the stand includes two brackets and the second bracket is disposed on the body at the top. The brackets may be u-shaped.

In some embodiments, the first bracket and the protrusion are positioned on opposite sides of the body at approximately the same height.

It is preferred that the protrusion is set at a 45° angle relative to the body. It is also preferred that the leg formed by the body and the body are at a 90° angle relative to each other and are separated by a curved transition portion. However, it is contemplated that other angles may be used in association with the present invention.

It is also preferred that the legs of the outrigger member are separated by a curved transition portion.

It is contemplated that the legs each include a cap made from a material which increases friction. The stand is preferably made from metal. Accordingly, such caps will also function to protect any flooring by being a material that is less abrasive than metal. Furthermore, it is contemplated that the metal may be covered or coated with another material, like latex. One of ordinary skill in the art will appreciate that other materials may be used in association with the present invention.

In another embodiment, the present invention comprises a kit including a carbon dioxide discharge horn, an accessory for same, and a stand. The carbon dioxide discharge horn preferably includes an open end capable of discharging solid carbon dioxide and a handle. The accessory may be an overblow shield. The stand preferably includes a body, a plurality of legs, at least a first bracket capable of holding the carbon dioxide discharge horn and a protrusion capable of supporting the accessory.

A stand as described herein can store a hand-operated discharge horn when it is not in use. In addition, such a stand is easy to set up, is easily movable and is not fixed in position with respect to a gas source. Furthermore such a stand is capable of supporting an accessory for use with the discharge horn.

It is to be understood that the aspects and objects of the present invention described above may be combinable and that other advantages and aspects of the present invention will become apparent to those having ordinary skill in the art upon reading the following description of the drawings and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is a back perspective view of a stand according to one or more embodiments of the present invention.

FIG. 2 is a front view of the stand shown in FIG. 1.

FIG. 3 is a side view of the stand shown in FIG. 1.

FIG. 4 is a top view of the stand shown in FIG. 1.

FIG. 5 is a front elevation view of a preferred hand-operated discharge horn used in association with the present invention.

FIG. 6 is a front view of an accessory used in association with the present invention.

### DETAILED DESCRIPTION OF THE DRAWINGS

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects, or other similar language does not imply that all of the features, advantages, or objects that may be realized with the present invention should be, or are, in any single embodiment of the invention. Rather, language referring to the features, advantages, or objects is understood to mean that specific features, advantages, or objects described in connection with an embodiment is included in at least one embodiment of the present invention. Thus, any discussion of the features, advantages, or objects throughout this specification may, but does not necessarily, refer to the same embodiment.

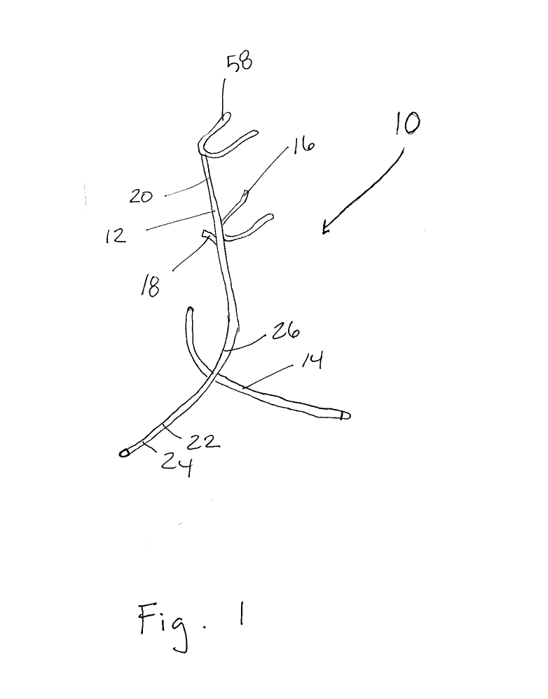

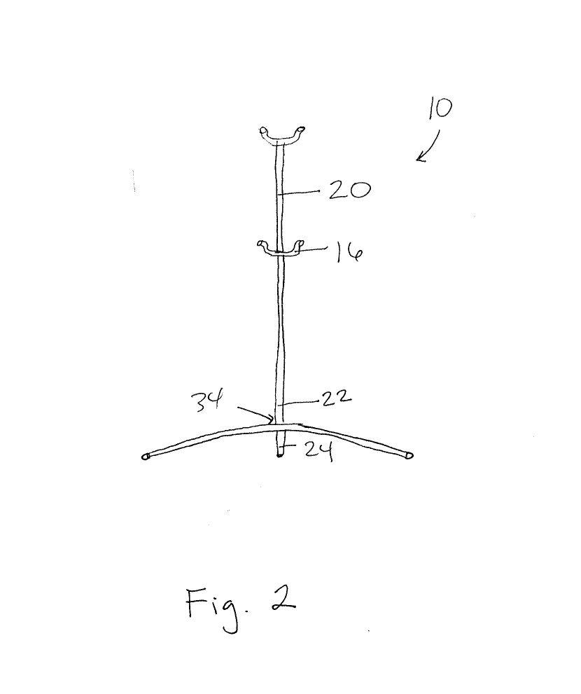

As shown in FIGS. 1-4, stand 10 according to various embodiments of the present invention includes body 12, outrigger member 14, first bracket 16, and protrusion 18.

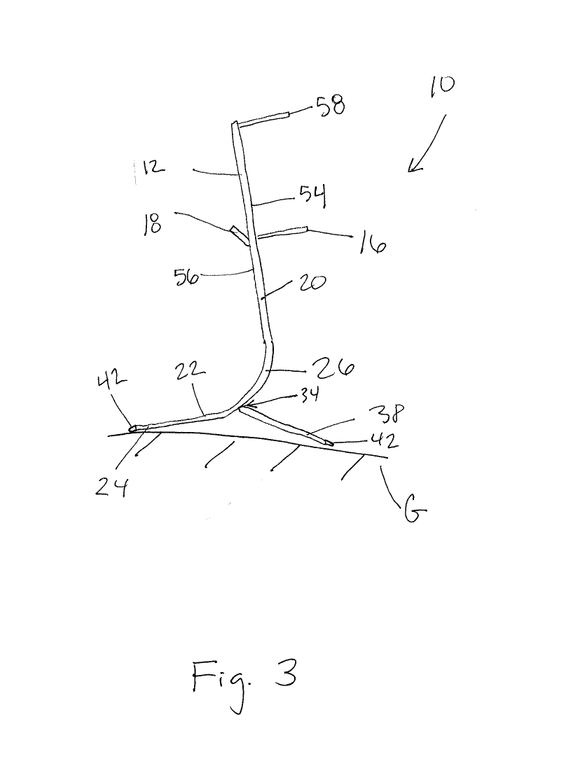

Body 12 includes top 20 and bottom 22. It is preferred that bottom 22 forms leg 24. It is further preferred that leg 24 and body 12 are at a 90° angle relative to each other and are separated by curved transition portion 26 (see, FIG. 3).

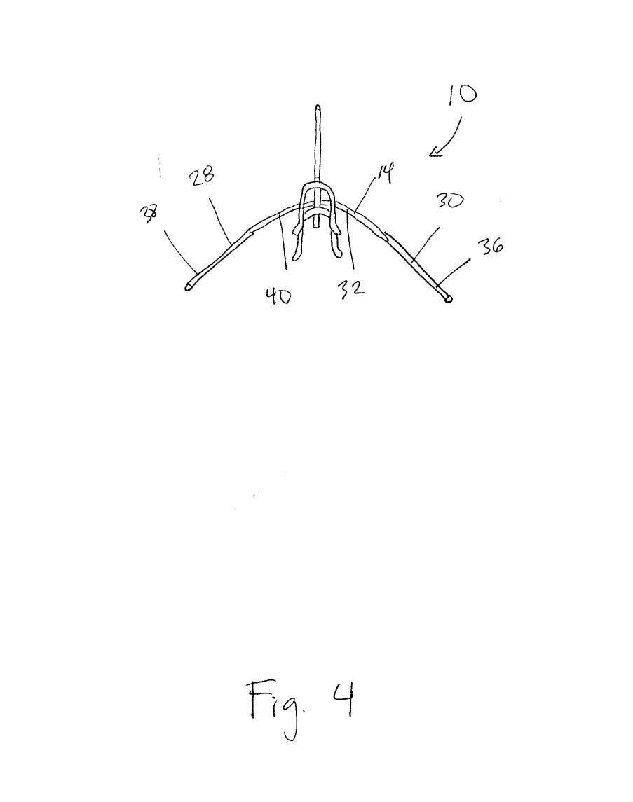

Shown in FIG. 4, outrigger member 14 has two ends 28, 30 and middle portion 32. Body 12 and middle portion 32 interest at point 34 between top 20 and bottom 22 of body 12. Each end 28, 30 of outrigger member 14 forms leg 36, 38—which are separated from each other by curved portion 40.

As can be seen in FIG. 3, preferably legs 24, 36, 38 support body 12 such that body 12 is angled relative to a line perpendicular to the plane of ground G. Additionally, each leg 24, 36, 38 may include cap 42 or other such covering.

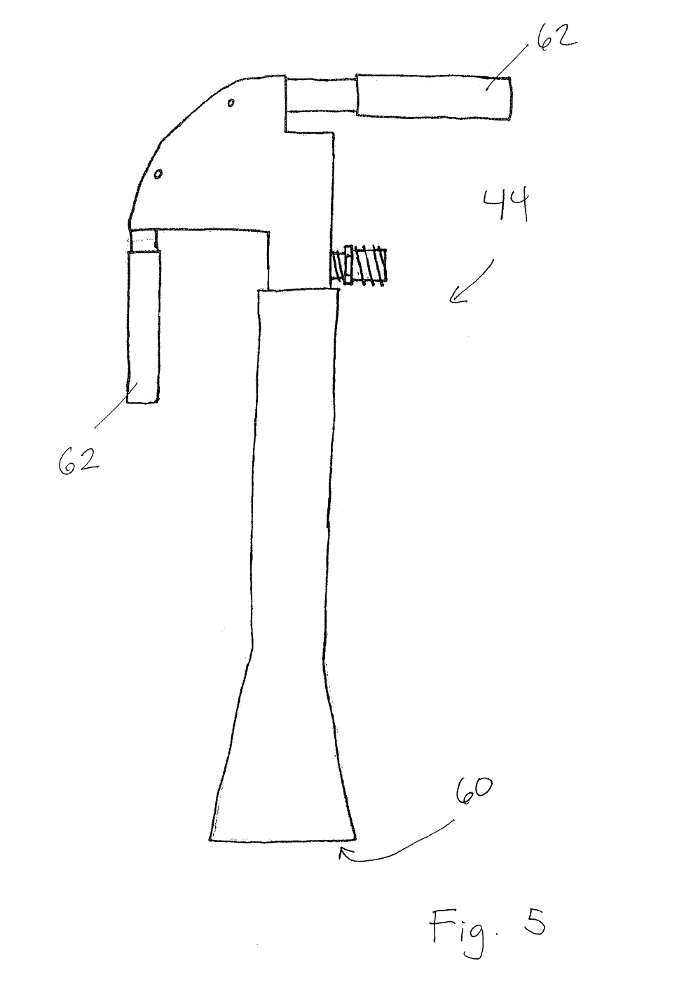

First bracket 16 is capable of hanging an object and is positioned on body 12 between point 34 and top 20. It is preferred that object is a hand-operated carbon dioxide discharge horn 44 (shown in FIG. 5).

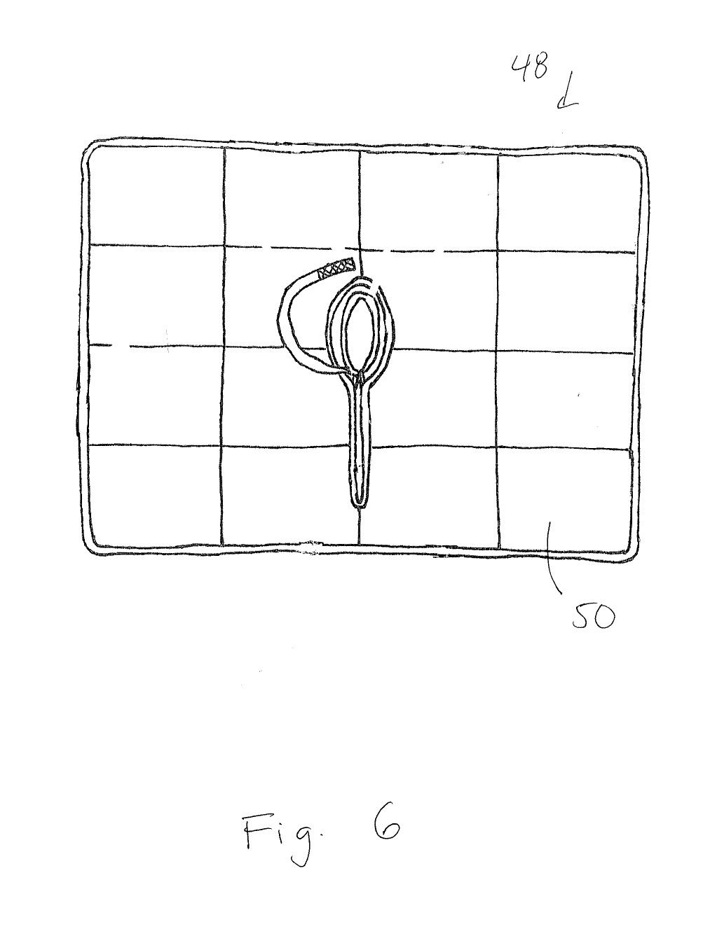

As seen in FIG. 1, for example, protrusion 46 is capable of hanging/retaining a second object and is similarly positioned on body 12 between point 34 and top 20. Protrusion 46 can have any shape, like a bracket, nub, extension, tab or other shape which is capable of supporting an object. It is preferred that protrusion 46 includes an axis that is at a 45° angle relative to body 12. It is preferred that the second object is accessory 48, such as overblow shield 50 (shown in FIG. 6).

In a preferred embodiment, first bracket 16 is disposed on first side 54 of body, and protrusion 46 is disposed on second side 56 of body 12 which is different than first side 54. In a most preferred embodiment, second side 56 is opposite first side 54. Additionally, first bracket 16 and protrusion 46 may be positioned on body 12 at approximately a same height (i.e., distance from ground G).

Stand 10 preferably includes second bracket 58. Brackets 16, 58 can have any shape, but are preferably u-shaped (as shown in FIG. 4) to receive the contemplated hand operated discharge horn 44.

The present invention also comprises a kit which includes carbon dioxide discharge horn, accessory for same, and stand.

As shown in FIG. 5, carbon dioxide discharge horn 44 preferably includes an open end 60 capable of discharging solid carbon dioxide and a handle 62.

As shown in FIG. 6, accessory 48 may be an overblow shield 50.

The stand may be the one described above, but preferably includes body, a plurality of legs, at least a first bracket capable of holding the carbon dioxide discharge horn and a protrusion capable of supporting the accessory.

Such a stand, or a kit with a stand, provides a device capable of storing a hand-operated discharge horn which is easy and quick to set up and which is capable of being used proximate the source of carbon dioxide, or used at a distance from the source of carbon dioxide. Further, such a stand provides a means to store both the hand-operated discharge horn and an accessory for same.

These and other benefits should be readily apparent to those of ordinary skill in the art.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A stand comprising:
a body having a top and a bottom, the bottom forming a leg;
an outrigger member having two ends and a middle, the middle intersecting the body at a point between the top and the bottom, and each end forming a leg;
a first bracket for hanging an object positioned on the body between the point the outrigger member intersects the body and the top; and,
a protrusion disposed on the body for hanging a second object, the protrusion positioned on the body between the point the outrigger member intersects the body and the top.

2. The stand of claim 1 wherein the first bracket is disposed on a first side of the body, and the protrusion is disposed on a second side of the body which is different than the first side.

3. The stand of claim 2 wherein the second side is opposite the first side.

4. The stand of claim 1 wherein the legs support the body such that body is angled.

5. The stand of claim 1 further comprising a second bracket disposed on the body at the top.

6. The stand of claim 5 wherein the first bracket and the protrusion are positioned on opposite sides of the body at approximately a same height.

7. The stand of claim 6 wherein the first and second brackets are u-shaped.

8. The stand of claim 1 wherein the protrusion is set at a 45° angle relative to the body.

9. The stand of claim 1 wherein the leg formed by the body and the body are at a 90° angle relative to each other and are separated by a curved transition portion.

10. The stand of claim 1 wherein the legs of the outrigger member are separated by a curved transition portion.

11. The stand of claim 1 wherein each leg includes a cap.

12. A stand comprising:
a body having a top, a bottom, a first side, and a second side, the bottom forming a leg and the first side being opposite the second side;
an outrigger member having two ends and a middle, the middle intersecting the body at a point between the top and the bottom, and each end forming a leg;
a first bracket for hanging an object position proximate the top of the body on the first side;
a second bracket for hanging the object positioned between first bracket and the bottom, on the first side; and,
a protrusion disposed on the second side of the body for hanging a second object, the protrusion positioned at a height that is substantially the same as a height of the second bracket.

13. The stand of claim 12 wherein the protrusion is set at a 45° angle relative to the body.

14. The stand of claim 12 wherein the leg formed by the body and the body are at a 90° angle relative to each other and are separated by a curved transition portion.

15. The stand of claim 12 wherein the legs of the outrigger member are separated by a curved transition portion.

16. A kit comprising:
a carbon dioxide discharge horn having an open end capable of discharging solid carbon dioxide and a handle;
an accessory for the carbon dioxide discharge horn: and,
a stand having a body, a plurality of legs, at least a first bracket capable of holding the carbon dioxide discharge horn and a protrusion capable of supporting the accessory.
